(19) United States
(12) Patent Application Publication
(10) Pub. No.: US 2010/0130320 A1
(43) Pub. Date: May 27, 2010

(54) CHAIN TENSIONER

(76) Inventors: Satoshi Kitano, Iwata (JP); Seiji Sato, Iwata (JP); Kouichi Onimaru, Iwata (JP); Tasuku Furukawa, Iwata (JP)

Correspondence Address: WENDEROTH, LIND & PONACK, L.L.P., 1030 15th Street, N.W.,, Suite 400 East, Washington, DC, 20005-1503, US

(21) Appl. No.: 12/620,069

(22) Filed: Nov. 17, 2009

(30) Foreign Application Priority Data
Nov. 21, 2008 (JP) 2008-297606

(51) Int. Cl. F16H 7/08

(52) U.S. Cl. 474/110

(57) ABSTRACT

A chain tensioner includes a cylindrical cylinder having a closed end, a plunger slidably mounted in the cylinder, and a return spring biasing the plunger. The cylinder is formed with an oil supply passage through which hydraulic oil is introduced into a pressure chamber defined by the plunger and the cylinder. The oil supply passage has an orifice at its end portion facing the pressure chamber. A leak gap is defined between sliding surfaces of the plunger and the cylinder. A damper force is produced by viscous resistance of hydraulic oil flowing from the pressure chamber through the leak gap, and by viscous resistance of hydraulic oil flowing from the pressure chamber into the oil supply passage through the orifice.

### BACKGROUND OF THE INVENTION

This invention relates to a chain tensioner for maintaining the tension of a chain for driving camshafts of an automotive engine.

In a typical automotive engine, the rotation of the crankshaft is transmitted to camshafts through a chain, thereby rotating the camshafts and opening and closing valves of the combustion chambers. In order to keep the tension of the chain within a suitable range, a tension adjusting device is frequently used which includes a chain guide pivotable about a pivot shaft and a chain tensioner for pressing the chain through the chain guide.

A typical chain tensioner used in such a tension adjusting device includes a cylindrical cylinder having open and closed ends, a plunger axially slidably mounted in the cylinder, and a return spring biasing the plunger in a direction to protrude from the cylinder (see JP Patent 3670911 and JP Patent Publication 2001-124159A).

In this chain tensioner, the plunger is adapted to move until the biasing force of the return spring balances with the tension of the chain, thereby suppressing fluctuations in the tension of the chain.

The cylinder is formed with an oil supply passage for introducing hydraulic oil into a pressure chamber defined by the plunger and the cylinder. A check valve is provided at the end of the oil supply passage facing the pressure chamber which allows only the flow of hydraulic oil from the oil supply passage into the pressure chamber. A leak gap is defined between sliding surfaces of the plunger and the cylinder through which hydraulic oil in the pressure chamber can leak.

With this arrangement, when the tension of the chain increases and the plunger is pushed into the cylinder, the check valve closes, and a damper force is produced by the viscous resistance of hydraulic oil that flows through the leak gap. The plunger thus moves slowly in this direction. When the tension of the chain decreases, and the plunger protrudes from the cylinder, the check valve opens, allowing hydraulic oil to flow into the pressure chamber from the oil supply passage. Thus, the plunger moves quickly in this direction.

In this type of chain tensioner, because the damper force produced when the plunger is pushed into the cylinder is proportional to the moving speed of the plunger in this direction, when the engine rpm is high and the vibration of the chain is large, the damper force may grow too large, resulting in over-tensioning of the chain.

One way to prevent the over-tensioning of the chain would be to increase the leak gap 16, thereby reducing the damper force. But this solution has a drawback in that the plunger becomes more likely to incline relative to the cylinder, which in turn increases wear of the portion of the inner periphery of the cylinder that is in contact with the plunger.

An object of the present invention is to minimize the leak gap between the sliding surfaces of the plunger and the cylinder, thereby reducing inclination of the plunger, and preventing wear of the inner periphery of the cylinder.

### SUMMARY OF THE INVENTION

In order to achieve this object, the present invention provides a chain tensioner comprising a cylindrical cylinder having an open end and a closed end, a plunger slidably mounted in the cylinder, a return spring biasing the plunger in a direction to protrude from the cylinder, the cylinder being formed with an oil supply passage through which hydraulic oil is introduced into a pressure chamber defined by the plunger and the cylinder, the oil supply passage having an orifice at an end portion of the oil supply passage facing the pressure chamber for restricting the flow rate of hydraulic oil from the oil supply passage into the pressure chamber, wherein a leak gap is defined between sliding surfaces of the plunger and the cylinder through which hydraulic oil in the pressure chamber can leak, whereby a damper force is produced by viscous resistance of hydraulic oil flowing from the pressure chamber through the leak gap, and by viscous resistance of hydraulic oil flowing from the pressure chamber into the oil supply passage through the orifice.

With this arrangement, since it is possible to reduce the damper force by adjusting the dimensions of the orifice, it is not necessary to increase the leak gap in order to prevent over-tensioning of the chain. Thus, it is possible to reduce inclination of the plunger relative to the cylinder.

When the engine is stopped, the tension, of the chain may be kept high according to the stopped positions of the camshafts. In such a case, if the plunger is markedly pushed in under the tension of the chain, the chain tends to slacken when the engine is restarted, which may make it difficult to smoothly start the engine.

In order to prevent the plunger from being further pushed in when the engine is stopped, the chain tensioner may be further provided with a register ring received in an annular ring-receiving groove formed in an inner periphery of the cylinder and elastically tightly wrapped around an outer periphery of the plunger, the register ring being engageable in any of a plurality of axially spaced circumferential grooves formed in the outer periphery of the plunger, the circumferential grooves each comprising a tapered surface along which the register ring can slide axially while radially expanding when loads are applied to the plunger that tend to push the plunger out of the cylinder, and a stopper surface that engages the register ring and restricts the movement of the plunger when loads are applied to the plunger that tend to push the plunger into the cylinder.

With this arrangement, even if the tension of the chain is kept high when the engine is stopped, by the engagement of the register ring in one of the circumferential grooves, the plunger is prevented from being pushed into the cylinder. Thus, when the engine is restarted, the chain is less likely to slacken, so that the engine can be started smoothly.

The orifice may be formed directly in the cylinder. But preferably, the orifice is formed in an orifice member which is a separate member from the cylinder and press-fitted in and fixed in position in the cylinder. With this arrangement, the orifice can be formed more easily and with higher accuracy. The orifice member may be formed by pressing a metal sheet for lower cost. But the orifice member may be formed by forging or sintering to ensure sufficient length of the orifice.

In another arrangement for preventing the plunger from being further pushed in when the engine is stopped, the plunger is a cylindrical member having an open end located in the cylinder and a closed end, the chain tensioner further comprising a screw rod having an external thread formed on an outer periphery thereof and in threaded engagement with an internal thread formed on an inner periphery of the plunger, and a rod seat disposed in the cylinder, the screw rod having one end thereof protruding from the plunger and in abutment with the rod seat.

With this arrangement, even if the tension of the chain is kept high when the engine is stopped, the internal thread of the plunger is supported by the external thread of the screw rod, so that the plunger is never pushed further into the cylinder. Thus, when the engine is restarted, the chain is less likely to slacken, so that the engine can be started smoothly.

The orifice may be directly formed in the cylinder. But preferably, the orifice is formed in the rod seat and the rod seat is press-fitted in and fixed in position in the cylinder. With this arrangement, the orifice can be formed more easily and with higher accuracy. The rod seat is preferably formed by forging or sintering to ensure sufficient length of the orifice.

Preferably, the orifice has a diameter within the range of 0.3 to 1.5 mm.

If the cylinder is made of aluminum, by providing a surface hardening film on the inner periphery of the cylinder, it is possible to effectively prevent wear of the inner periphery of the cylinder. Especially if this chain tensioner is mounted in a diesel engine, it is possible to suppress wear of the portion of the cylinder 9 that is in contact with the plunger 10 due to soot contained in hydraulic oil, thereby ensuring stable damper force over a long period of time.

The surface hardening film may be e.g. an anodic oxide film. Its surface hardness is preferably not less than Hv 400 to ensure wear resistance of the inner periphery of the cylinder.

In the chain tensioner according to this invention, because the damper force can be reduced by adjusting the dimensions of the orifice, it is not necessary to increase the leak gap in order to prevent over-tensioning of the chain. Thus, it is possible to reduce inclination of the plunger relative to the cylinder, thereby reducing wear of the inner periphery of the cylinder due to inclination of the plunger.

Since the flow rate of hydraulic oil from the oil supply passage into the pressure chamber is restricted by the orifice, even when the engine rpm is high and the vibration of the chain is large, the amount of hydraulic oil flowing into the pressure chamber never increases excessively. This reduces the distance by which the plunger protrudes.

### BRIEF DESCRIPTION OF THE DRAWINGS

FIG. 1 is a front view of a chain transmission device including a chain tensioner according to a first embodiment of the present invention;

FIG. 2 is an enlarged sectional view of the chain tensioner of FIG. 1;

FIG. 3 is an enlarged sectional view of an orifice member shown in FIG. 2;

FIG. 4 is an enlarged sectional view of a chain tensioner modified from the chain tensioner of FIG. 2; and

FIG. 5 is an enlarged sectional view of a chain tensioner according to a second embodiment of the present invention.

### DETAILED DESCRIPTION OF THE PREFERRED EMBODIMENTS

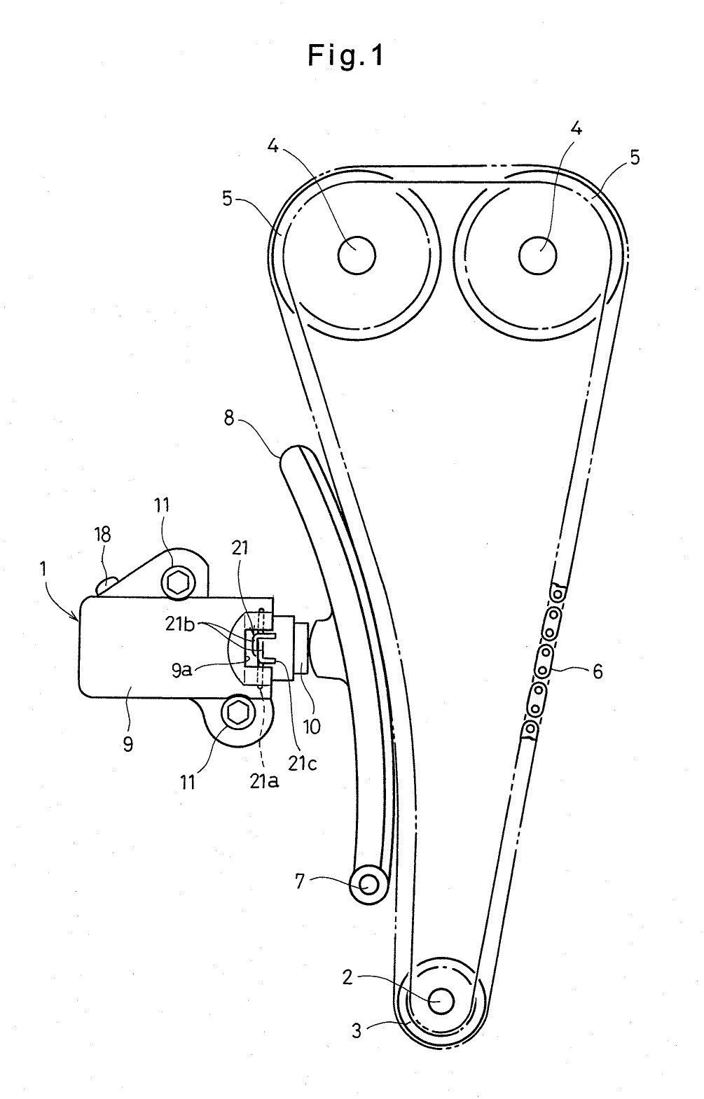

FIG. 1 shows a chain transmission device including a chain tensioner 1 according to the first embodiment of the present invention. This chain transmission device includes a sprocket 3 fixed to an engine crankshaft 2, sprockets 5 fixed to respective camshafts 4, and a chain 6 coupling the sprockets 3 and 5 together for transmitting the rotation of the crankshaft 2 to the camshafts 4, thereby rotating the camshafts 4 and opening and closing valves (not shown) of combustion chambers.

A chain guide 8 is pivotally supported on a pivot shaft 7 so as to be kept in contact with the chain 6. The chain 6 is pressed by the chain tensioner 1 through the chain guide 8.

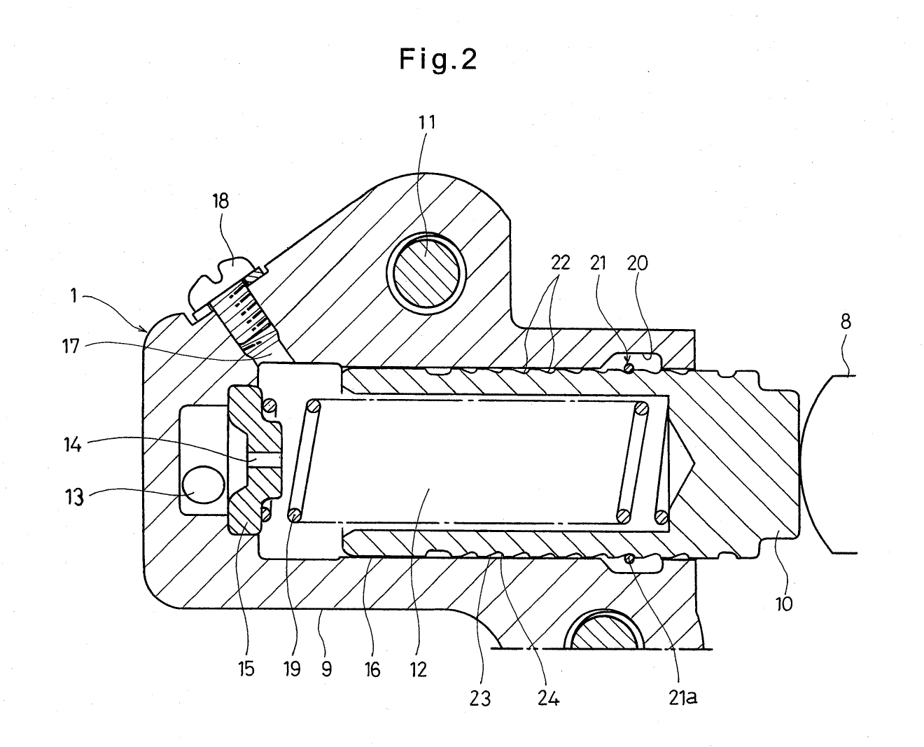

As shown in FIG. 2, the chain tensioner comprises a cylindrical cylinder 9 having open and closed ends, and a plunger 10 axially slidably inserted in the cylinder 9. The cylinder 9 is fixed to an engine block (not shown) by bolts 11.

The cylinder 9 is made of aluminum. A surface hardening film is provided on the inner periphery of the cylinder 9. The surface hardening film may be an anodic oxide film (also called “anodized aluminum film”), an electroless plating film (such as an electroless nickel plating film), a film formed by nitriding, or a film formed by ion implantation. If an anodic oxide film is used as the surface hardening film, the surface hardening film should have a hardness of not less than Hv 400 to ensure high wear resistance of the inner periphery of the cylinder 9.

The cylinder 9 is formed with an oil supply passage 13 communicating with a pressure chamber 12 defined by the cylinder 9 and the plunger 10. The oil supply passage 13 is connected to an oil pump (not shown) to introduce hydraulic oil from the oil pump into the pressure chamber 12. An orifice 14 is provided at the end of the oil supply passage 13 facing the pressure chamber 12 to restrict the flow of hydraulic oil into the pressure chamber 12 from the oil supply passage 13.

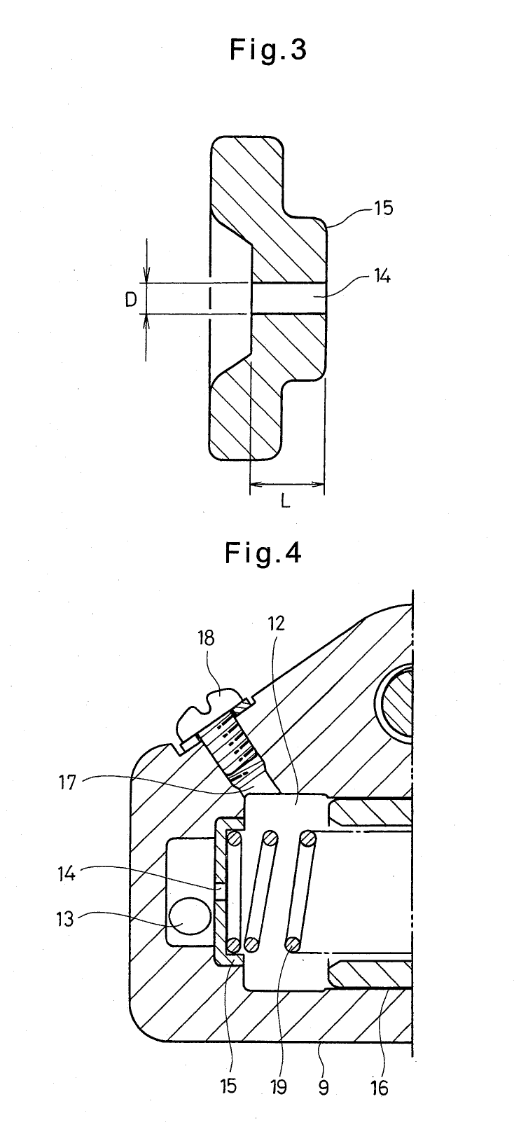

The orifice 14 is formed in an orifice member 15 which is provided separately from the cylinder 9. The orifice member 15 is formed by forging iron or sintering ferrous green compact, and is pressed into the cylinder 9 so as to be fixed in position in the cylinder 9. The orifice 14 is a small-diameter hole through which the oil supply passage 13 communicates with the pressure chamber 12. When the pressure in the pressure chamber 12 is higher than the pressure in the oil supply passage 13, hydraulic oil in the pressure chamber 12 is adapted to flow into the oil supply passage 13 through the orifice 14. The orifice 14 shown in FIG. 3 has a diameter D of 0.3 to 1.5 mm. Preferably, the orifice 14 has a length L that is about three times its diameter D.

As shown in FIG. 2, an annular leak gap 16 is defined between the sliding surfaces of the plunger 10 and the cylinder 9. Through the leak gap 16, hydraulic oil can flow out of the pressure chamber 12.

The cylinder 9 is further formed with a through hole 17 extending from its radially outer surface to its radially inner surface. A screw 18 is in threaded engagement with an internal thread formed on the inner surface of the through hole 17. Air in the pressure chamber 12 can be expelled through the gap between the screw 18 and the internal thread.

The plunger 10 is biased outwardly of the cylinder 9 by a return spring 19 mounted in the pressure chamber 12. The return spring 19 has its one end supported by the orifice member 15 and the other end pressed against the plunger 10.

An annular ring-receiving groove 20 is formed in the inner periphery of the cylinder 9. A register ring 21 is axially movably received in the ring-receiving groove 20. The register ring 21 has circumferential ends and is radially and elastically deformable. The register ring 21 is elastically tightly wrapped around the outer periphery of the plunger 10 and is engageable in any one of a plurality of axially spaced circumferential grooves 22 formed in the outer periphery of the plunger 10.

Each circumferential groove 22 comprises a tapered surface 23 along which the register ring 21 can slide axially while radially expanding when loads are applied to the plunger 10 that tend to push the plunger 10 out of the cylinder 9, and a stopper surface 24 that engages the register ring 12 and restricts the movement of the plunger 10 when loads are applied to the plunger 10 that tend to push the plunger 10 into the cylinder 9.

Now the operation of this chain tensioner is described.

When the tension of the chain 6 increases while the engine is running, the plunger 10 is pushed into the cylinder under the tension of the chain 6, thereby reducing the tension of the chain 6. When the plunger 10 is pushed in, the plunger 10 moves slowly due to the damper force produced by the viscous resistance of hydraulic oil that flows through the leak gap 16 from the pressure chamber 12 and the viscous resistance of hydraulic oil that flows from the pressure chamber 12 into the oil supply passage 13 through the orifice 14.

When the tension of the chain 6 decreases while the engine is running, the plunger 10 protrudes from the cylinder under the biasing force of the return spring 19, thereby removing slackness of the chain 6. At this time, the plunger 10 moves quickly because hydraulic oil flows into the pressure chamber 12 from the oil supply passage 13.

While the engine is running, the plunger 10 moves back and forth due to vibration of the chain 6, so that the register ring 21 moves back and forth in the ring-receiving groove 20. When the plunger 10 protrudes until the register ring 21 contacts the front wall of groove 20 and further protrudes, the register ring 21 slides along the tapered surface 23 of the circumferential groove 22 while radially expanding, and engages in the next circumferential groove 22, thereby allowing protrusion of the plunger 10.

When the engine is stopped, the tension of the chain 6 may remain relatively high according to the stopped positions of the camshafts 4. In this state, since the register ring 21 is in engagement with one of the circumferential grooves 22, the plunger 10 cannot be pushed further into the cylinder 9. Thus, when the engine is restarted, the chain is less likely to slacken, so that the engine can be started smoothly.

In this chain tensioner 1, since the damper force produced when the plunger 10 is pushed into the cylinder 9 is substantially proportional to the moving speed of the plunger 10, when the engine rpm is high and the vibration of the chain 6 is large, the damper force may grow too large, resulting in over-tensioning of the chain 6. One way to prevent the over-tensioning of the chain 6 is to increase the leak gap 16, thereby reducing the damper force. Another way is to adjust the dimensions of the orifice 14 so as to reduce the damper force.

If the leak gap 16 is increased to reduce the damper force, the plunger 10 tends to incline relative to the cylinder 9. But by adjusting the dimensions of the orifice 14 to reduce the damper force, it is not necessary to increase the leak gap 16, so that the plunger 10 is less likely to incline. Thus, with the arrangement of the present invention, because it is possible to reduce the damper force by adjusting the dimensions of the orifice 14, it is possible to prevent the inner periphery of the cylinder 9 from becoming worn due to inclination of the plunger 10.

Further, because this chain tensioner 1 has the surface hardening film on the inner periphery of the cylinder 9, it is possible to effectively prevent wear of the inner periphery of the cylinder 9. Especially if this chain tensioner 1 is mounted in a diesel engine, it is possible to suppress wear of the portion of the cylinder 9 that is in contact with the plunger 10 due to soot contained in hydraulic oil, thereby ensuring stable damper force over a long period of time.

Also, since the flow rate of hydraulic oil from the oil supply passage 13 into the pressure chamber 12 is restricted by the orifice 14, when the engine rpm and thus the vibration of the chain 6 increase, it is possible to prevent the flow rate of hydraulic oil into the pressure chamber 12 from increasing excessively, thereby suppressing the protruding amount of the plunger 10.

In this chain tensioner 1, since the orifice 14 is formed in the orifice member 15, which is a separate member from the cylinder 9, the orifice 14 can be formed more easily and with higher accuracy than when the orifice 14 is formed directly in the cylinder 9.

In this embodiment, the orifice member 15 is formed by forging or sintering to ensure sufficient length of the orifice 14. But as shown in FIG. 4, the orifice member 15 may be formed by pressing a metal sheet for lower cost. In this case, the length of the orifice 14 may be adjusted to 0.3 to 1.5 mm.

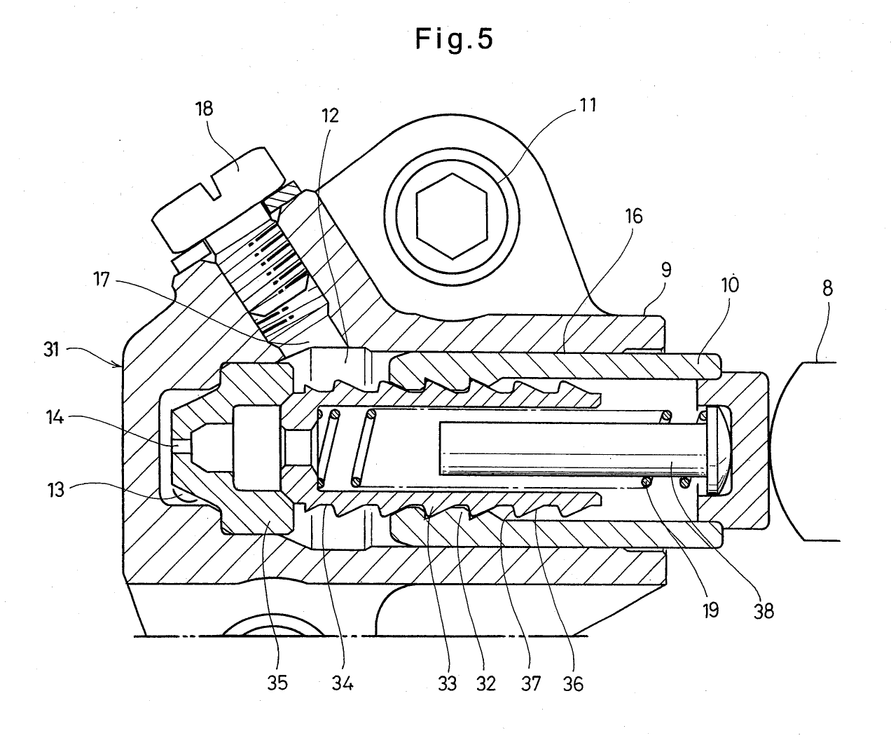

FIG. 5 shows the chain tensioner 31 according to the second embodiment. Elements corresponding to those of the first embodiment are denoted by identical numerals and their description is omitted.

The plunger 10 is a cylindrical member having an open end located inside the cylinder 9 and a closed end, and formed with an internal thread 32 on the inner periphery thereof. A screw rod 34 having an external thread 33 on the outer periphery thereof is inserted in the plunger 10 with the external thread 33 in threaded engagement with the internal thread 32. The screw rod 34 has its one end protruding from the plunger 10 and supported on a rod seat 35 disposed in the cylinder 9.

The external thread 33 and the internal thread 32 each comprise a pressure flank 36 which receives pressure when loads are applied to the plunger 10 that tend to push the plunger 10 into the cylinder, and a clearance flank 37, the pressure flank 36 having a larger flank angle than the clearance flank 37. Thus, the internal and external threads 32 and 33 have a serration-shaped longitudinal section.

A return spring 19 is mounted in a pressure chamber 12 defined by the cylinder 9 and the plunger 10. The return spring 19 has one end thereof supported on the screw rod 34 and the other end pressed against the plunger 10 through a spring seat 38, thereby biasing the plunger 10 outwardly of the cylinder 9.

The orifice 14 is formed in the rod seat 35. The rod seat 35 is formed by forging iron or sintering ferrous green compact, and pressed into and fixed in position in the cylinder 9. The orifice 14 has a length of 0.5 to 5 mm. The size of the leak gap 16, i.e. the difference between the radii of the sliding surfaces of the plunger 10 and the cylinder 9 is adjusted to 0.015 to 0.080 mm.

Now the operation of this chain tensioner 31 is described.

When the tension of the chain 6 increases while the engine is running, the plunger 10 is pushed into the cylinder 9 under the tension of the chain 6, thereby absorbing the tension of the chain 6. At this time, the screw rod 34 rotates relative to the plunger 10, while moving back and force within the range of the axial gap between the internal thread 32 and the external thread 33. Also, under the damper force produced by the viscous resistance of hydraulic oil that flows from the pressure chamber 12 through the leak gap 16, and the viscous resistance of hydraulic oil that flows from the pressure chamber 12 into the oil supply passage 13 through the orifice 14, the plunger 10 moves slowly in this direction.

When the tension of the chain 6 decreases while the engine is running, the plunger 10 is pushed out of the cylinder 9 under the biasing force of the return spring 19, thereby removing slackness of the chain 6. At this time, the screw rod 34 separates from the rod seat 35, so that the plunger 10 can move a longer distance than the axial gap between the internal thread 32 and the external thread 33. Also, since hydraulic oil flows from the oil supply passage 13 into the pressure chamber 12, the plunger 10 can quickly move in this direction.

When the engine is stopped, the tension of the chain 6 may remain relatively high according to the stopped positions of the camshafts 4. In this state, because the chain 6 does not vibrate, the internal thread 32 of the plunger 10 is supported by the external thread 33 of the screw rod 34, so that the plunger 10 is never pushed further into the cylinder 9. Thus, when the engine is restarted, the chain is less likely to slacken, so that the engine can be started smoothly.

In this chain tensioner 31, since the damper force produced when the plunger 10 is pushed into the cylinder 9 is substantially proportional to the moving speed of the plunger 10, when the engine rpm is high and the vibration of the chain 6 is large, the damper force may grow too large, resulting in over-tensioning of the chain 6.

One way to prevent the over-tensioning of the chain 6 would be to increase the leak gap 16, thereby reducing the damper force. Another way is to adjust the dimensions of the orifice 14 so as to reduce the damper force.

If the leak gap 16 is increased to reduce the damper force, the plunger 10 tends to incline relative to the cylinder 9. But by adjusting the dimensions of the orifice 14 to reduce the damper force, it is not necessary to increase the leak gap 16, so that the plunger 10 is less likely to incline. Thus, with the arrangement of the present invention, because it is possible to reduce the damper force by adjusting the dimensions of the orifice 14, it is possible to prevent the inner periphery of the cylinder 9 from becoming worn due to inclination of the plunger 10.

Also, since the flow rate of hydraulic oil from the oil supply passage 13 into the pressure chamber 12 is restricted by the orifice 14, when the engine rpm and thus the vibration of the chain 6 increase, it is possible to prevent the flow rate of hydraulic oil into the pressure chamber 12 from increasing excessively, thereby suppressing the protruding amount of the plunger 10.

In this chain tensioner 31, since the orifice 14 is formed in the rod seat 35, which is a separate member from the cylinder 9, the orifice 14 can be formed more easily and with higher accuracy than when the orifice 14 is formed directly in the cylinder 9.

What is claimed is:

1. A chain tensioner comprising a cylindrical cylinder having an open end and a closed end, a plunger slidably mounted in the cylinder, and a return spring biasing the plunger in a direction to protrude from the cylinder, said cylinder being formed with an oil supply passage through which hydraulic oil is introduced into a pressure chamber defined by the plunger and the cylinder, said oil supply passage having an orifice at an end portion of the oil supply passage facing the pressure chamber for restricting the flow rate of hydraulic oil from the oil supply passage into the pressure chamber, wherein a leak gap is defined between sliding surfaces of the plunger and the cylinder through which hydraulic oil in the pressure chamber can leak, whereby a damper force is produced by viscous resistance of hydraulic oil flowing from the pressure chamber through the leak gap, and by viscous resistance of hydraulic oil flowing from the pressure chamber into the oil supply passage through the orifice.

2. The chain tensioner of claim 1 further comprising a register ring received in an annular ring-receiving groove formed in an inner periphery of the cylinder and elastically tightly wrapped around an outer periphery of the plunger, said register ring being engageable in any of a plurality of axially spaced circumferential grooves formed in the outer periphery of the plunger, said circumferential grooves each comprising a tapered surface along which the register ring can slide axially while radially expanding when loads are applied to the plunger that tend to push the plunger out of the cylinder, and a stopper surface that engages the register ring and restricts the movement of the plunger when loads are applied to the plunger that tend to push the plunger into the cylinder.

3. The chain tensioner of claim 2 further comprising an orifice member which is a separate member from the cylinder and press-fitted in and fixed in position in the cylinder, said orifice being formed in the orifice member.

4. The chain tensioner of claim 3 wherein the orifice member is a forged or sintered member.

5. The chain tensioner of claim 3 wherein the orifice member is a pressed metal sheet.

6. The chain tensioner of claim 1 wherein said plunger is a cylindrical member having an open end located in the cylinder and a closed end, the chain tensioner further comprising a screw rod having an external thread formed on an outer periphery thereof and in threaded engagement with an internal thread formed on an inner periphery of the plunger, and a rod seat disposed in the cylinder, said screw rod having one end thereof protruding from the plunger and in abutment with the rod seat.

7. The chain tensioner of claim 6 wherein the orifice is formed in the rod seat and wherein the rod seat is press-fitted in and fixed in position in the cylinder.

8. The chain tensioner of claim 7 wherein said rod seat is a forged or sintered member.

9. The chain tensioner of claim 1 wherein said orifice has a diameter within the range of 0.3 to 1.5 mm.

10. The chain tensioner of claim 1 wherein said cylinder is made of aluminum and a surface hardening film is formed on an inner periphery of the cylinder.

11. The chain tensioner of claim 10 wherein said surface hardening film is an anodic oxide film.

12. The chain tensioner of claim 10 wherein said surface hardening film has a hardness of not less than Hv 400.

13. The chain tensioner of claim 11 wherein said surface hardening film has a hardness of not less than Hv 400.
